(19) United States
(12) Patent Application Publication
(10) Pub. No.: US 2024/0332613 A1
(43) Pub. Date: Oct. 3, 2024

(54) RECONFIGURABLE SOFT LITHIUM-ION BATTERY

(71) Applicant: THE REGENTS OF THE UNIVERSITY OF CALIFORNIA, Oakland, CA (US)

(72) Inventors: Liwei Lin, Moraga, CA (US); Peisheng He, Albany, CA (US); Yande Peng, Albany, CA (US); Yu Long, Berkeley, CA (US)

(21) Appl. No.: 18/580,879

(22) PCT Filed: Jul. 12, 2022
(86) PCT No.: PCT/US2022/036765

§ 371 Date: Jan. 19, 2024

Related U.S. Application Data
(60) Provisional application No. 63/223,781, filed on Jul. 20, 2021.

(51) Int. Cl. H01M 10/0565; H01M 4/02; H01M 4/04; H01M 4/485; H01M 4/58; H01M 50/474; H01M 50/486

(52) U.S. Cl. CPC H01M 10/0565; H01M 4/0404; H01M 4/0414; H01M 4/485; H01M 4/5815; H01M 50/474; H01M 50/486; H01M 2004/027; H01M 2004/028

(57) ABSTRACT

A conformable battery including a first polymer substrate having a cathode, a second polymer substrate having an anode facing the cathode, and a hydrogel electrolyte in between the anode and cathode. A method of manufacturing a stretchable battery includes forming a cathode current collector on a first polymer substrate, depositing a cathode on the cathode current collector, forming an anode current collector on a second polymer substrate, depositing an anode on the anode current collector, depositing a hydrogel electrolyte on one of either the cathode or the anode, and joining the first polymer substrate and the second polymer substrate to form the battery.

### CROSS REFERENCE TO RELATED APPLICATION

This application claims priority to and the benefit of U.S. Provisional Application No. 63/223,781 filed Jul. 20, 2021, which is incorporated herein by reference in its entirety.

### TECHNICAL FIELD

This disclosure relates to lithium-ion batteries, more particularly to soft-packaged lithium-ion batteries that can conform to irregular surfaces.

### BACKGROUND

Safe and reconfigurable batteries that can be conformably embedded onto irregular surfaces of electrical systems and human body are desirable for wearable electronic applications without impeding mobility of individuals. The current state of the art lithium-ion (Li-ion) batteries in the commercial market are packaged in rigid hermetic sealing materials that are not deformable. In the research laboratories, state of the art deformable batteries reported in research articles all degrade quickly due to severe performance problems such as the penetration of moistures and the leakage of toxic and inflammable electrolytes. Safe and reconfigurable batteries that can be conformably embedded onto irregular surfaces of various electronics systems are desirable features for military/commercial applications, including but not limited to systems such as night vision, tracking, and tagging of soldiers without impeding their mobility.

However, the current state-of-art Li-ion batteries on the commercial market requires rigid packaging for the hermetic sealing to prevent the intrusion of moisture that degrades performance, and the leakage of toxic and flammable electrolytes due to mechanical damage. On the other hand, research articles have reported various deformable/stretchable batteries and they have shown good conformability but suffered from significant performance degradation over time (S. Xu, et al., Not. Commun. 2103; 4:1543) with low operation hours (D. G. Mackanic, et al., Adv. Energy Mater. 2020, 2001424) in the ambient environment (L. Suo, et al., Science, 350 (6263), 938-943).

The fundamental challenge for the flexible battery lies in the inextricable linkage between the modulus of elasticity and gas permeability of materials. A conformable battery needs to use materials with low elastic modulus containing a high amount of free volume between polymer chains for its flexibility. However, this will allow penetrations of moisture resulting in fast performance degradation. Furthermore, the conventional organic electrolyte typically utilized in most of these deformable batteries are both toxic and flammable while the flexible polymer package materials can be easily damaged without meeting harsh working environments.

### BRIEF DESCRIPTION OF THE DRAWINGS

FIG. 1 shows examples of devices with different geometries.

FIG. 2 shows stress v. strain curves of an embodiment of hydrogel electrolyte.

FIG. 3 shows a measured electrochemical stability window of an embodiment of an aqueous hydrogel electrolyte.

FIG. 4 shows a schematic diagram showing a structural layout and materials for an embodiment of a reconfigurable lithium-ion battery.

FIG. 5 shows images of an embodiment of a battery being bent and stretched.

FIG. 6 shows a graph of a specific capacity and coulomb efficiency of an embodiment of a battery over 100 cycles in the ambient environment for tests over 2 months.

FIG. 7 shows an embodiment of a method of manufacturing batteries with hydrogel electrolyte.

FIG. 8 shows an embodiment of a method of roll-to-roll manufacturing batteries with hydrogel electrolyte.

### DETAILED DESCRIPTION OF THE EMBODIMENTS

To allow user-friendly experiences, compact and flexible/stretchable devices are desirable to allow seamless integrated systems for human-machine interface applications. Reconfigurable and soft batteries will play an important role as power sources can take up a large space in a system. To this end, the conformable/stretchable batteries of the embodiments provide an ideal power sources for these devices. Wearable devices attract lots of interest with a market share of over $116.2 billion/year, projected to be $265.4 billion by 2026.

In addition, medical and healthcare sectors will also benefit from the embodiments. Driven by recent development in big data and machine learning, the digital healthcare market has grown rapidly in recent years due to its potential to provide smooth healthcare functions to individuals with an estimated market size of US $116.39 billion now and projected to grow to $833.44 billion by 2027. Systems that comply with changes in the human body without limiting the mobility of individuals are desirable, and reconfigurable soft batteries will be indispensable in those systems.

The embodiments here propose innovations to circumvent the problems with existing soft batteries, including the usage of a non-toxic, aqueous hydrogel electrolyte instead of organic electrolytes. The hydrogel electrolyte is shown to: enable highly safe operations due to its non-toxic nature; alleviate the moisture penetration problem from outside environment; have a high-voltage working window (˜2.77 V) for high energy density batteries; and allow the construction of reconfigurable and soft batteries by using elastic polymer packaging materials instead of rigid hermetic seals.

In the prototype tests, fabricated batteries have shown ultrahigh stretchability and flexibility with a radius of curvature less than 2 mm, to enable conformal attachments to a wide range of geometric surfaces as reconfigurable batteries. Remarkably, the prototype battery also shows outstanding cyclic stability and to retain approximately 90% of its original capacity after 100 cycles for over 2 months in the ambient environment without using any rigid hermetic sealing package. Furthermore, the preliminary data, without device optimizations, on the specific energy density is measured as high as 1.5 mAh/cm³, without further optimizing.

A roll-to-roll manufacturing process could be readily setup to fabricate this soft battery for large-scale production to lower the manufacturing cost. This technology makes an excellent fit as the solution for the safe, printable, and conformal batteries for wearable electronic devices. After optimization in materials and system, packaging designs, and large-scale manufacturing, the embodiments could potentially address the needs for commercial and military applications, including but not limited to warfighters as well as consumer electronics and medical/healthcare devices such as the next generation wearable electronics systems.

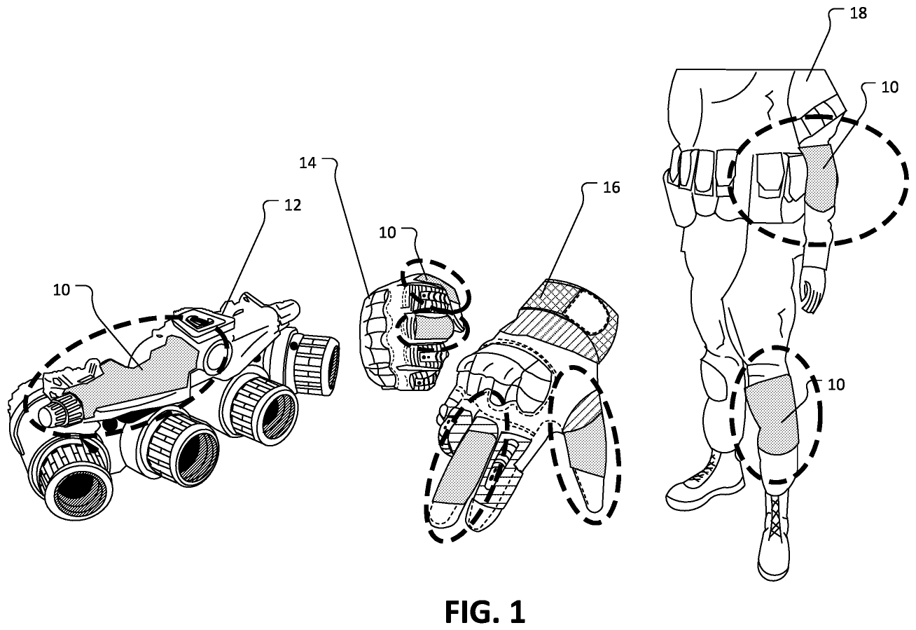

The embodiments here circumvent the problems in current approaches by replacing the conventional organic electrolyte with an aqueous hydrogel electrolyte with the advantages listed above. FIG. 1 shows examples of surfaces to which the conformable battery and packaging 10 may attach. The examples include night vision goggles 12 with the battery and packaging 10 molded to the top of the module, gloves shown in a first closed example 14 and open hand example 16, and the battery as body wearable packages, such as on the forearm or leg, as examples. These merely provide examples, the battery could attach to weapon surfaces, such as gunstocks, radio casings, etc.

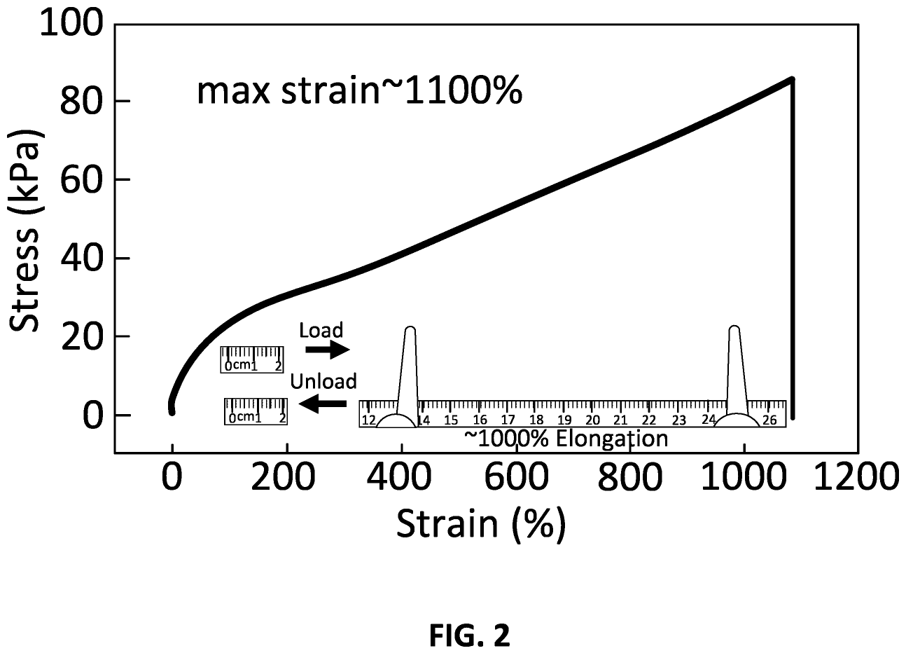

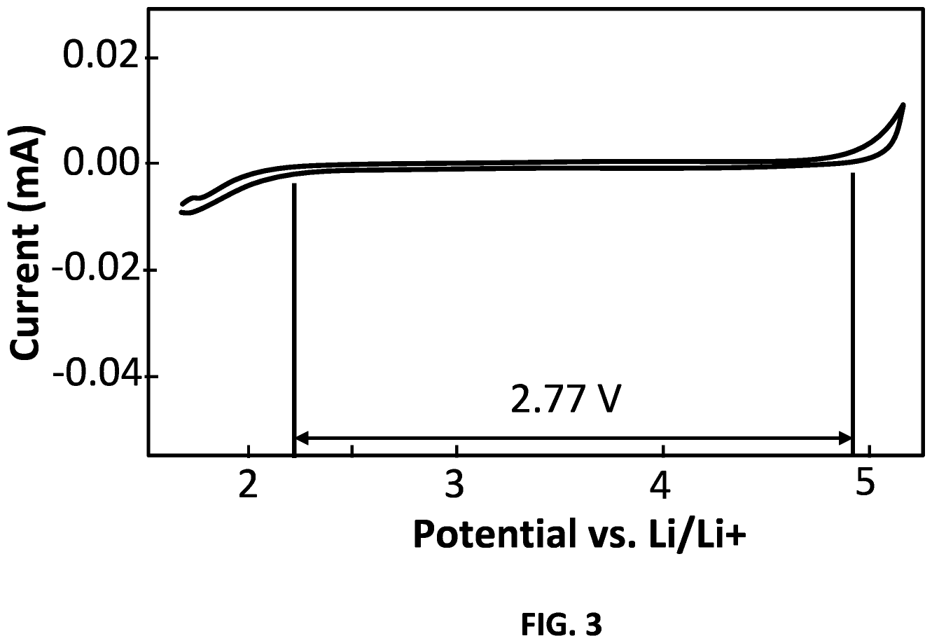

In preliminary tests, the hydrogel is highly elastic and stretchable of over 1000% without fracture to ensure good mechanical robustness. FIG. 2 shows a graph of stress versus strain for the hydrogel of the embodiments. Embodiments of the hydrogel have an embedded “water-in-salt” (WiS) electrolyte to broaden the electrochemical stability window and the high concentration of lithium salt can suppress the decomposition of water by the solvation of salt anions and cations. As shown in FIG. 3, the stability window is measured to reach 2.77 V, which is over 2 times higher than those of conventional systems to drastically increase the energy density of the battery. In one embodiment, a stretchable hydrogel electrolyte with the high electrochemical stability window mentioned above has a dual-crosslinked polymer network, and a highly concentrated salt solution.

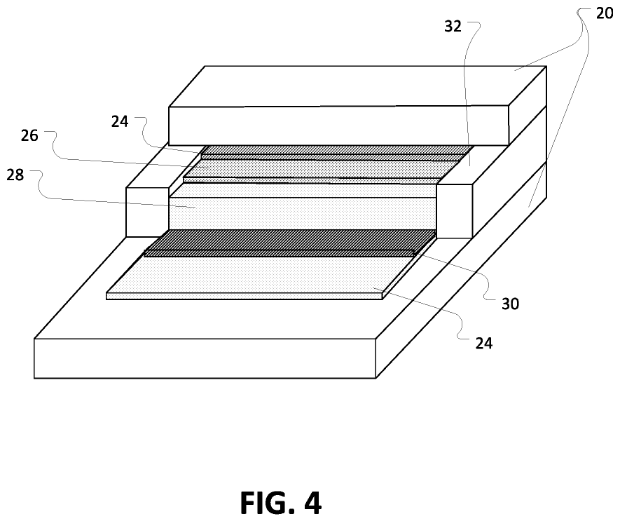

Based on the high-voltage-window and stretchable hydrogel, a prototype battery has been developed as shown in FIG. 4, with the layers cut away to show the structure. Packaging 20 will generally comprise a polymer material that may provide manufacturing substrates as discussed in more detail below. The current collectors 24 reside adjacent the packaging on either side of the battery layers. The hydrogel 28 separates the two electrodes 26 and 30, one being the anode and the other the cathode. The hydrogel acts as both the electrolyte and separator due to its excellent electrochemical stability, ion conductivity and mechanical properties. In one embodiment, the hydrogel, together with encircling sealant 32 lies sandwiched between two printed electrode layers, which consists of stencil-printed current collectors and anode/cathode on an elastic polymer substrate. In another embodiment, the battery does not include the sealant, or sealing ring. The polymer substrates for the anode and cathode may have sufficient adhesion and sealing capabilities that remove the need for the sealing ring.

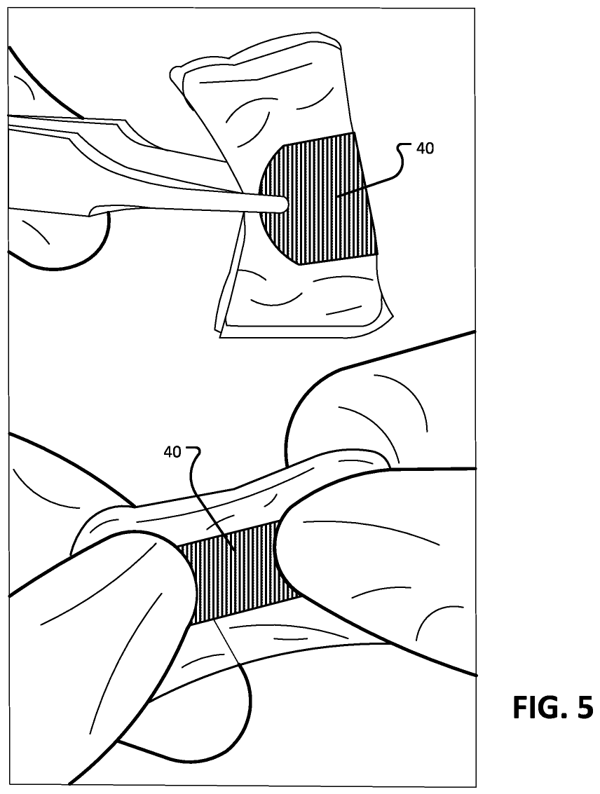

Due to the high tolerance to moisture provided by the aqueous hydrogel electrolyte, no additional packaging material was used. This allows the embodiments to show excellent conformity. The prototype device 40 can be bent with a radius of curvature less than 2 mm even stretched by greater than 50% as shown in FIG. 5. The radius of curvature may be less than 5 mm, or 10 mm, or may have a range of less than 2 mm to zero. Specific values may include 2 mm, 1 mm, and 0.1 mm. In addition to being able to be bent, the battery is self-healing. In an experiment, a battery packaged in its polymer was cut into two pieces and then put back together with no leakage and the healed battery functioned as before. Self-healing as used here means the ability to be cut into pieces and returned to its original functionality.

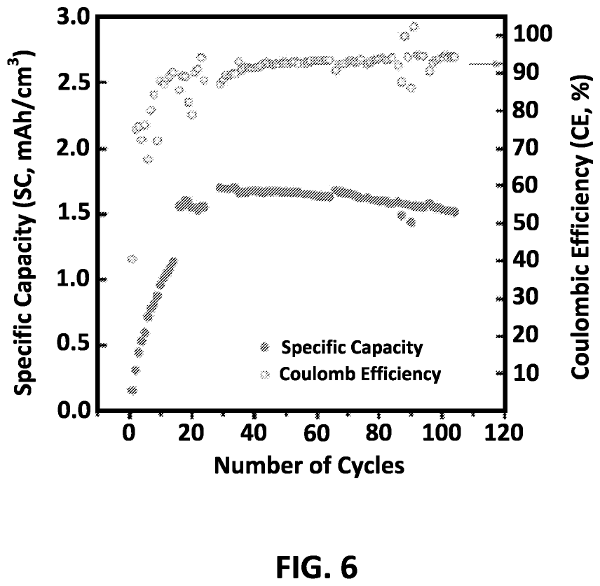

The battery may be stretchable in a range from 50%, meaning 50% larger than the original package, to 100% stretchable, meaning the stretched package may be twice the size of the original. In addition, without hermetic sealing, the prototype shows outstanding cyclic stability to retain ˜90% of capacity after 100 cycles for over 2 months as tested in the ambient environment. FIG. 6 shows a graph of the specific capacity versus the number of cycles.

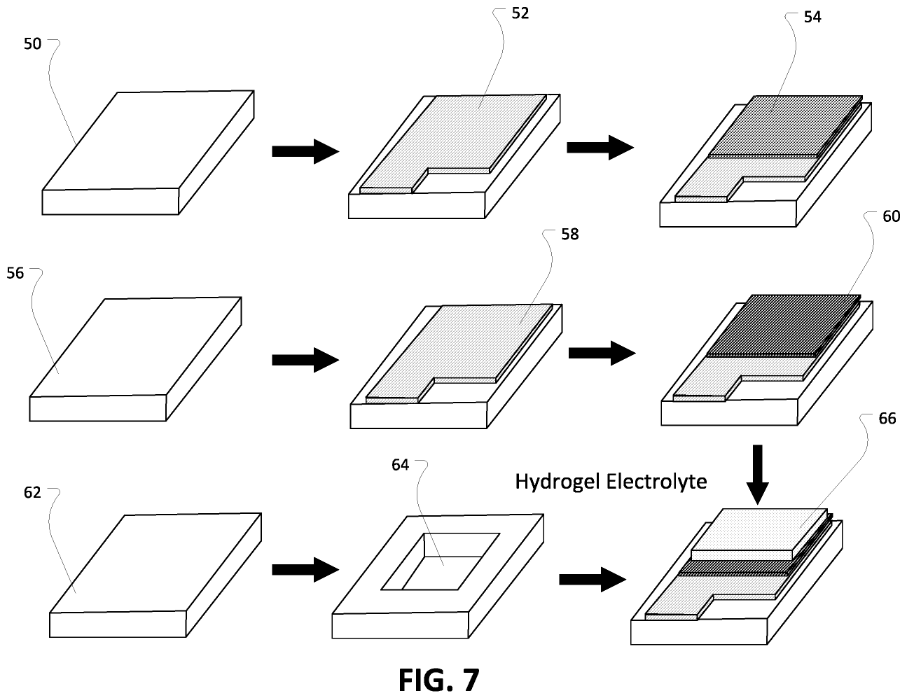

FIG. 7 shows an embodiment of a fabrication process. The process begins with two elastomer substrates 50 and 56, in this embodiment. A printing process may fabricate the electrodes in a layer-by-layer fashion on elastomer substrates. Each elastomer substrate 50 and 56 receives a first layer of a current collector 52 and 58, respectively. The process prints the anode layer on one current collector and the cathode on the other current collector. In this embodiment, the process prints the anode 54 on the current collector 52 and the cathode 60 on the current collector 58. The substrate 62 comprises the sealing ring that surrounds the hydrogel, if used. The process would place the substrate 62 holding the hydrogel onto either the cathode or the anode. In this embodiment, the cathode receives the substrate 62 and the hydrogel 66. The view of FIG. 7 does not show the substrate 62 to allow the hydrogel 66 to be seen. The substrate 50 holding the anode and current collector turns upside down in this view and then forms a sandwich with the substrate 56, with the hydrogel lying in the middle. The package formed of the substrates may seal itself, or may use the sealing substrate 62 between then. If the sealing ring were used, an alternative to filling the opening with the hydrogel would involve depositing the hydrogel adding the sealant ring provided after the deposition.

The resulting conformal battery has a first polymer substrate having a cathode, a second polymer substrate having an anode facing the cathode, an optional polymer spacer between the first cathode surface and the first anode surface. The polymer spacer has an opening that holds the hydrogel electrolyte in the opening.

The stretchable hydrogel electrolyte with high electrochemical stability window has a dual-crosslinked polymer network, and a highly concentrated salt solution. The dual-crosslinked polymer network may result from many at least one of many different types of monomers mixed with a polymerization initiator, and a crosslinker. The monomers may include a combination of a first monomer, such as acrylic acid or acrylamide, and a second monomer such as [2-(Methacryloyloxy) ethyl]dimethyl-(3-sulfopropyl) ammonium hydroxide, or only a first monomer without a second monomer. The crosslinker may comprise N,N′-Methylenebisacrylamide, and the initiator may comprise a thermal initiator such as ammonium persulfate, or a photoinitator such as azobisisobutyronitrile (AIBN). As used here the term “highly concentrated” refers to a salt concentration of at least 5 moles of salt per kilogram of water.

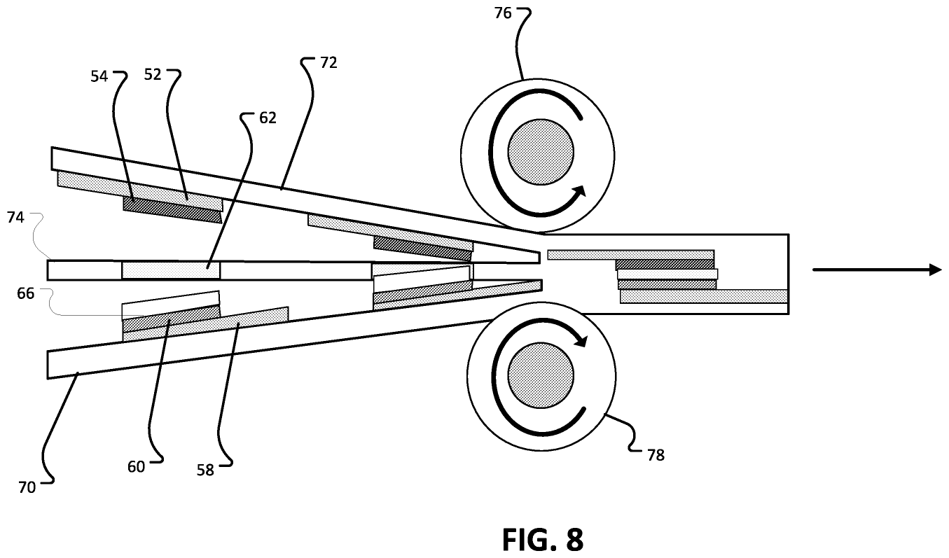

These materials and processes are compatible with a high throughput, roll-to-roll fabrication process, allowing easy setup of a large-scale, low-cost manufacturing process. FIG. 8 shows an embodiment of such a process. In FIG. 8, a first roll of polymer substrate material 70 has printed on it the current collector 58, the cathode 60 and the hydrogel, 66. The second roll 72 has the current collector for the anode 52 and the anode 54. If the sealing ring is used, a third roll 74 transports the sealing ring with its hydrogel opening space 62. As the two or three rolls enter the area between the two compression rollers 76 and 78, the structures on the two outer rolls 70 and 72, mate up with either each other, or each other and sealing ring with its the hydrogel opening space 62 on the roll 74 The resulting battery structure exits the compression rollers. The combined roll of battery structures may undergo further processing such as dicing or cutting to form individual batteries.

One should note that the positions of the anode and cathode on the respective rolls merely provide one embodiment. The positions of the structures may vary, including having the cathode on the top and the anode on the bottom, as well as the placement of the hydrogel on either the top or bottom. Further, the process could include the sealant ring being on either roll, eliminating the third roll. The overall process involves forming the battery from opposed rolls of material that combine to form the final battery structure. No restriction or limitation to any particular implementation is intended nor should any be implied.

In addition, the compositions of the electrode and current collector slurry can be further adjusted to accommodate other printing processes such as gravure printing, screen printing, or inkjet printing. Different cathode and anode materials could be used. In one embodiment, lithium manganese oxide (LMO) makes up the cathode and vanadium oxide, (V₂O₅) makes up the anode. This configuration achieves a discharge voltage of ˜1.75 V. With new anode/cathode materials, high, meaning higher than 2.0V, voltage output can be expected. Another embodiment uses molybdenum sulfide (MO₆S₈) as the anode, which may achieve a discharge voltage of approximately 2.7V. The rheological behavior of the slurry can be optimized to achieve the desired surface morphology. Furthermore, the ratio between active materials, conductive filling, and binder materials may be adjusted to maximum energy and power density. Finally, the highly stretchable elastomer utilized as the packing material and substrate in the prototype and the stability of device can be further enhanced by selecting other packaging materials for usages under severe weather and temperature conditions. The hydrogel electrolyte has significantly eased up the strict requirement for packaging and thus various polymer-based materials could be utilized.

The embodiments provide a good fit for safe, printable, and conformal batteries. First, the aqueous-based, non-toxic hydrogel electrolyte significantly reduces the safety risk associated with the leakage problem in batteries under possible mechanical wears and damages. The excellent mechanical stretching property of hydrogel also ensures the mechanical robustness of the device. Second, by utilizing water as the solvent in the electrolyte, the battery can tolerate the moisture penetration problem from the outside environment. This allows us to utilize elastic polymer substrates as the packaging materials as opposed to rigid hermetic sealing materials in the state-of-art Li-ion batteries. This soft and reconfigurable feature allows the mobility of soldiers during operations and the conformability of the battery on various surfaces. The embodiments of deformable batteries can be deployed on irregular surfaces, such as helmets, gunstocks, armors, weapons, etc., and can be distributed onto textile products such as uniforms. Therefore, the embodiments hold great promise as a ubiquitous energy storage candidate for empowering future electronic equipped soldiers or regular consumers without sacrificing their mobility during operations.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the embodiments.

What is claimed:

1. A conformable battery, comprising:
a first polymer substrate having a cathode;
a second polymer substrate having an anode facing the cathode; and
a hydrogel electrolyte between the cathode and the anode and in contact with the cathode and the anode.

2. The conformable battery as claimed in claim 1, wherein the first polymer substrate and the second polymer substrate comprise elastomers and form a package for the battery.

3. The conformable batter as claimed in claim 1, further comprising a polymer spacer between the cathode surface and the anode surface, the polymer spacer having an opening in which the hydrogel electrolyte resides.

4. The conformable battery as claimed in claim 1, wherein the battery is bendable to a radius of curvature of less than 2 mm.

5. The conformable battery as claimed in claim 1, wherein the battery is stretchable to a range of at least 50% to 100%.

6. The conformable battery as claimed in claim 1, wherein the hydrogel electrolyte has an electrochemical stability window of at least 2.77 V.

7. The conformable battery as claimed in claim 1, wherein the anode comprises one of vanadium oxide (V₂O₅) or molybdenum sulfide ((Mo₆S₈).

8. The conformable battery as claimed in claim 1, wherein the cathode comprises lithium metal oxide (LMO).

9. The conformable batter as claimed in claim 1, wherein the battery is self-healing.

10. A stretchable hydrogel electrolyte, comprising:
a dual-crosslinked polymer network; and
an aqueous salt solution embedded in the polymer.

11. The stretchable hydrogel electrolyte as claimed in claim 10, wherein the dual-linked polymer network comprises a polymer network resulting from one or more monomers selected from: acrylic acid, acrylamide, and [2-(Methacryloyloxy) ethyl]dimethyl-(3-sulfopropyl) ammonium hydroxide

12. The stretchable hydrogel electrolyte as claimed in claim 10, wherein the polymer network results from a crosslinker and a thermal initiator or a photoinitator.

13. The stretchable hydrogel electrolyte as claimed in claim 10, wherein the aqueous salt solution comprises a lithium salt solution.

14. The stretchable hydrogel electrolyte as claimed in claim 10, wherein the aqueous salt solution has a concentration of at least 5 moles of salt per kilogram of water.

15. A method of manufacturing a stretchable battery comprising:
forming a cathode current collector on a first polymer substrate;
depositing a cathode on the cathode current collector;
forming an anode current collector on a second polymer substrate;
depositing an anode on the anode current collector;
depositing a hydrogel electrolyte on one of either the cathode or the anode; and
joining the first polymer substrate and the second polymer substrate to form the battery.

16. The method of manufacturing as claimed in claim 15, wherein joining the first polymer substrate and the second polymer substrate forms a package for the battery.

17. The method of manufacturing as claimed in claim 15, further comprising using a sealing ring around the hydrogel electrode and joining the first polymer substrate and the second polymer substrate comprising joining the first polymer substrate to the second polymer substrate with the sealing ring.

18. The method of manufacturing as claimed in claim 15, wherein one or more of the deposition the cathode, depositing the anode, and depositing the hydrogel comprise printing.

19. The method of manufacturing as claimed in claim 18, wherein the printing comprises at least one of screen printing, gravure printing, and inkjet printing.

20. The method of manufacturing as claimed in claim 15, comprising a roll-to-roll process.
